(19) United States
(12) Patent Application Publication
(10) Pub. No.: US 2003/0212535 A1
(43) Pub. Date: Nov. 13, 2003

(54) Method and apparatus for simulating network jitter and packet loss

(76) Inventor: Nagendra Goel, McLean, VA (US)

Correspondence Address: LSI LOGIC CORPORATION, 1621 BARBER LANE, MS: D-106 LEGAL, MILPITAS, CA, 95035, US

(21) Appl. No.: 10/141,991

(22) Filed: May 9, 2002

(51) Int. Cl. G06F 17/10

(52) U.S. Cl. 703/2; 370/241; 703/13

(57) ABSTRACT

A jitter generation apparatus and method configured to capture time varying aspects of jitter and packet loss in packet networks for testing/debugging jitter control algorithms. The jitter generation algorithm includes a probabilistic markov model which includes at least one hidden state and a plurality of state-dependent distributions. At each packet arrival, the probabilistic markov model emits a number corresponding to the delay for that packet that comes from a distribution which is unique to the state that the model is in. The model also includes a state transition matrix, and is configured to possibly make a transition to some other state, as defined by the state transition probability matrix, upon emitting the number. In order to model packet loss, a state may be provided which always results in infinite delay. The parameters of the model may be “trained” using actual, collected network data.

### BACKGROUND

The present invention generally relates to apparatuses and methods for testing and/or debugging jitter control algorithms that are used in voice-over-packet voice communication systems, and more specifically relates to a jitter generation apparatus and method which captures the important time varying aspects of jitter and packet loss in real packet networks for testing and/or debugging jitter control algorithms, and the overall quality of voice-over-packet voice communication systems.

Sophisticated jitter control algorithms are often used in voice-over-packet products. It is desirable to test such algorithms for performance against packet loss and jitter control before such algorithms are released into the market. At present, due to the limited capabilities of jitter generation in laboratory environments, it is very difficult to test sophisticated jitter control algorithms. The main problem stems from the fact that jitter generation and packet loss algorithms which are used in the laboratory to test jitter control algorithms do not sufficiently simulate the way a real packet network actually acts in the field.

For example, to test jitter, typically a uniform random delay generator is used. A similar approach is used to test packet loss. Specifically, “Gilbert's model” is often used for packet loss generation, as such a model captures the correlation properties. However, packet loss and jitter are not combined into a single network scenario.

Existing solutions do not account for the fact that network properties change over time. While developers spend a lot of time developing adaptive techniques (i.e., sophisticated jitter control algorithms) to handle changes in network properties, the algorithms hit the market without any proper testing due to the inability to simulate the way a real packet network actually acts in the field.

### OBJECTS AND SUMMARY

A general object of an embodiment of the present invention is to provide a jitter generation apparatus and method which captures the important time varying aspects of jitter and packet loss, in real packet networks.

Another object of an embodiment of the present invention is to provide a probabilistic model and method which can be used to test jitter control algorithms, and which accounts for the fact that network properties change over time.

Still another object of an embodiment of the present invention is to provide a jitter generation apparatus and method which provides that sophisticated jitter control algorithms can be tested for jitter and packet loss before being released to market.

Still another object of an embodiment of the present invention is to provide a method to tune the parameters of the jitter generation apparatus to mimic the real network conditions.

Briefly, and in accordance with at least one of the forgoing objects, an embodiment of the present invention provides a jitter generation apparatus and method configured to capture time varying aspects of jitter and packet loss in packet networks for testing/debugging jitter control algorithms. The jitter generation apparatus is configured to implement a probabilistic markov model which includes at least one hidden state and a plurality of state-dependent distributions. At each packet arrival, the probabilistic markov model emits a number corresponding to the delay of that packet that comes from a distribution which is unique to the state that the model is in. The model also includes a state transition matrix, and is configured to possibly make a transition to some other state, as defined by the state transition probability matrix, upon emitting the number that corresponds to the packet delay. In order to model packet loss, a state may be provided which always results in infinite delay. The parameters of the model may be “trained” using actual, collected network data.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 is a block diagram of a probabilistic model which is in accordance with an embodiment of the present invention;

FIG. 2 is a block diagram of a method of using the probabilistic model shown in FIG. 1, to test and/or debug a jitter control algorithm, wherein the method is in accordance with an embodiment of the present invention;

FIG. 3 is a block diagram which shows an extension of the method shown in FIG. 2, wherein actual network data is collected and an expectation-maximization algorithm is used on the data to obtain parameters which are used in the probabilistic model shown in FIG. 1; and

FIG. 4 is a state diagram of a time varying network jitter simulator.

### DESCRIPTION

While the invention may be susceptible to embodiment in different forms, there are shown in the drawings, and herein will be described in detail, specific embodiments with the understanding that the present disclosure is to be considered an exemplification of the principles of the invention, and is not intended to limit the invention to that as illustrated and described herein.

An embodiment of the present invention provides an apparatus for packet network jitter generation, that captures the important time varying aspects of jitter and packet loss, in real packet networks. The apparatus is configured to implement a model, the parameters of which can be derived by studying real scenarios, in an iterative algorithmic manner. The apparatus provides that sophisticated jitter control algorithms can be tested and debugged before there is a problem in the field. The apparatus also helps in identifying problems and improving upon existing jitter control algorithms. In case of a problem with an already deployed product, the apparatus can be used to help mimic the network conditions under which the problem occurs, and then the problem can be reproduced in laboratory environments.

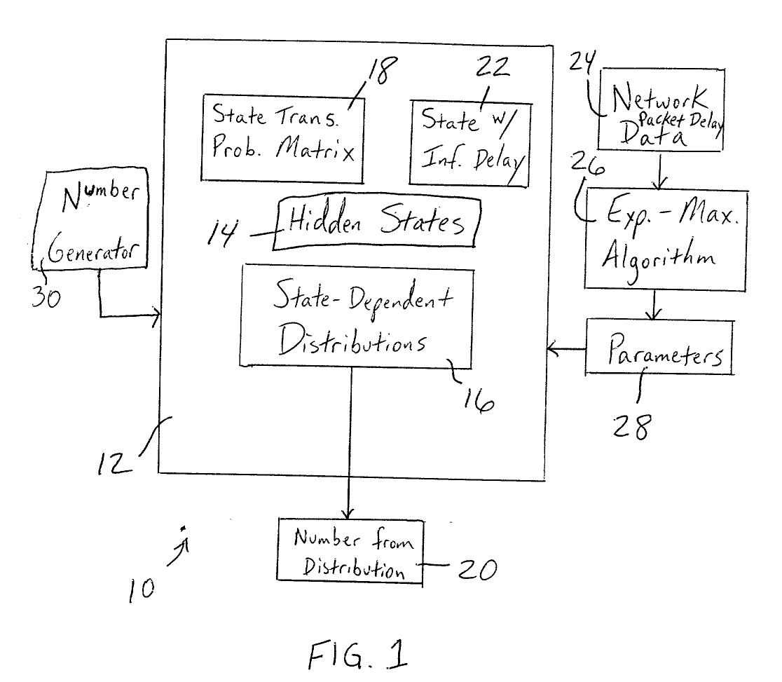

FIG. 1 schematically illustrates the jitter generation apparatus 10. Such apparatus can be in the form of software or a hardware implementation such as a chip, an ASIC, etc. As shown, the jitter generation apparatus is configured to implement a probabilistic markov model 12 which includes hidden states 14. A description relating to markov models can be found in an article by Louis A. Liporace entitled “Maximum Likelihood Estimation for Multivariate Observations of Markov Sources,” which was published in the September 1982 issue of IEEE Transactions on Information Theory (Vol. IT-28, No. 5, pages 729-734). A description of hidden states in markov models can be found in an article by L. R. Rabiner and B. H. Juang entitled “An Introduction to Hidden Markov Models,” which was published in the January 1986 issue of IEEE ASSP Magazine (pages 4-16). These articles are hereby incorporated herein in their entirety by reference.

The model 12 includes a plurality of state-dependent distributions 16 and a state transition probability matrix 18. At each packet arrival, the model 12 receives a number from a number generator 30 which effectively drives the state-dependent distributions 16 and the state transition probability matrix 18. The model 12 emits a number 20 corresponding to the delay for that packet 20 that comes from a distribution which is unique to the state that the model 12 is in. At that time, the model 12 may also make a transition to some other state, as defined by the state transition probability matrix 18. By appropriately setting the values of these parameters, one can have one state that gives low jitter, and another with high jitter, thus reflecting time varying properties of the network. For example, for a two state system, it can be shown that the period over which the network properties will change over time is about 1/p+1/q (where p is the probability of going from state 1 to state 2, and q is the probability of going from state 2 to state 1). Packet loss is modeled by providing an additional state 22 which always results in infinite delay.

If the model for jitter distribution (preferably, a uniform distribution is used when the parameters of the model are set manually) belongs to the exponential family, then preferably network delay data 24 is collected, and the parameters 26 of the model are “trained” from the network data, preferably using an expectation-maximization algorithm 28.

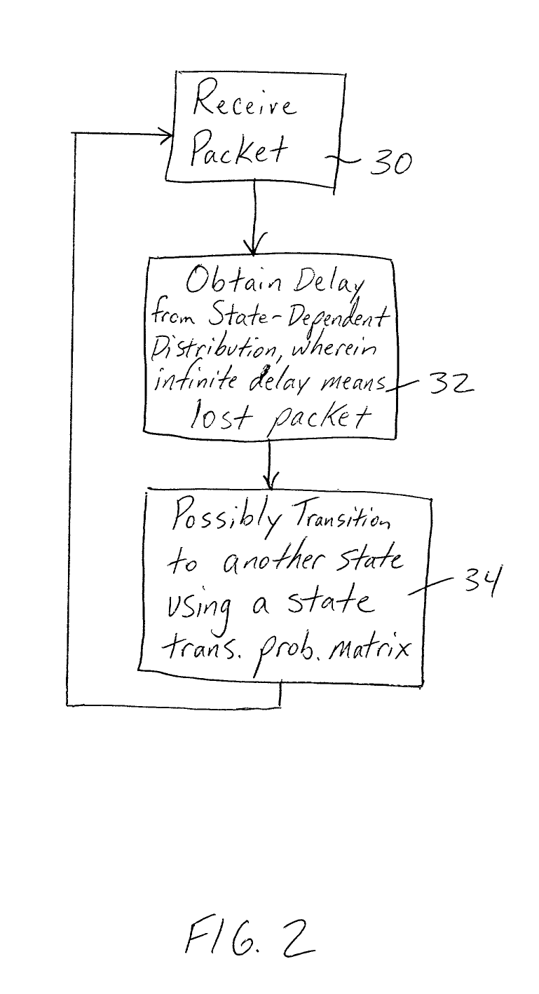

Hence, as shown in FIG. 2, a method of using the jitter generation apparatus provides that a packet is received (box 30) and a number is obtained that corresponds to the delay for that packet that comes from a distribution which is unique to the state that the model is in (box 32), wherein an infinite delay means that the packet has been lost. At that time, the model may also transition to some other state (box 34), as defined by a state transition probability matrix.

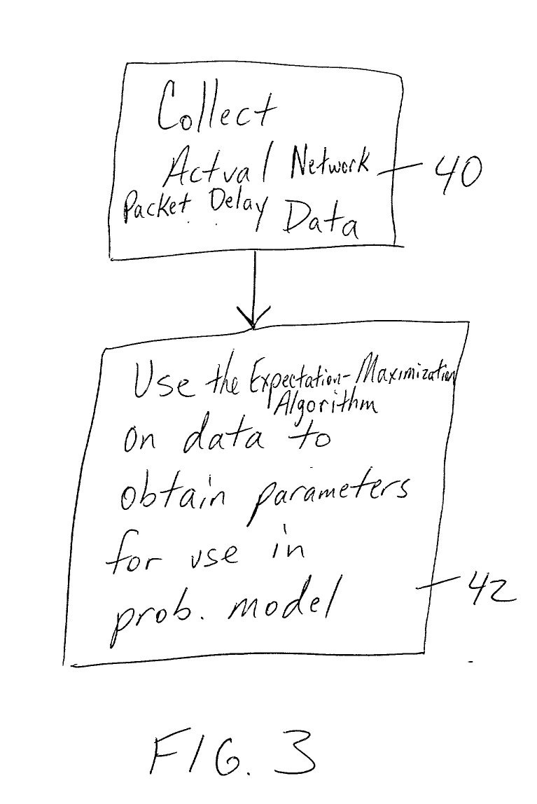

As discussed above and as shown in FIG. 3, network packet delay data may be collected (box 40), and the parameters of the model “trained” from the network data (box 42), preferably using an expectation-maximization algorithm.

The jitter generation apparatus which is in accordance with an embodiment of the present invention effectively provides that a markov model with hidden states is used to generate time varying packet loss and jitter, and that the parameters of the model can be “trained” to mimic network conditions. The apparatus provides that sophisticated jitter control algorithms can be tested and debugged before there is a problem in the field. The apparatus also helps in identifying problems and improving upon existing jitter control algorithms. In case of a problem with an already deployed product, the apparatus can be used to help mimic the network conditions under which the problem occurs, and then the problem can be reproduced in laboratory environments.

In order to achieve the delay that is generated by the jitter model described above, the packet is placed in a list that is sorted by the amount of delay. At every clock tick, the amount of delay is reduced. When the delay is reduced to zero, the packet is released to the other end of the network.

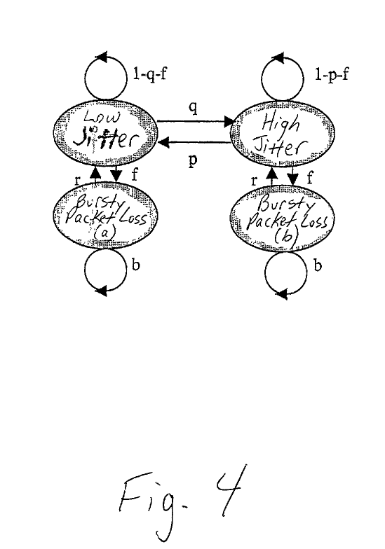

As discussed above, the model 12 can be implemented in hardware, such as a chip, an ASIC, etc., or can be implemented in software. An example of a software implementation is illustrated in FIG. 4, which provides a state diagram of a time-varying network jitter simulator. As shown in FIG. 4, the simulator could be in one of the four possible states. Each state is characterized by its own unique probability distribution for jitter. For example, the Low jitter state could cause network delays ranging from 20 to 50 milliseconds (jitter of 30 ms), while the High jitter state could cause network delays ranging from 40 to 200 milliseconds. In the packet loss states (“Bursty Packet Loss (a) and Bursty Packet Loss (b)”), the packet delay is infinite (i.e., in other words, that packet never reaches the destination, and is therefore lost). The state machine is also characterized by transition probabilities from one state to another. Whenever a packet arrives, it is sent to the destination after a delay that is derived from a pseudo-random number generator with the distribution corresponding to the current state of the state machine. At the same time, the state machine also makes a transition from its current state to the next state, on the basis of the transition probabilities. In a typical application, the user may only be interested in a general network scenario, and may not particularly be interested in every minute detail of the network simulation model. Therefore, In order to make it easy to specify the state machine, preferably the following parameters are defined from which the rest of the state machine parameters are derived.

MinDelay: The minimum delay that a packet will go through while crossing the network.

MaxDelay: The maximum delay that a packet will go through.

MeanDelay: The average delay that all packets will go through.

CycleTime: The network characteristics will vary form low-delay state to high-delay state, and back. This parameter specifies the average cycle period for these variations. This parameter should have a large value in order to simulate time varying network.

Volatility: This is the fraction of time spent in the High jitter states as compared to the low jitter state. This parameter should have a value in the range (0, 1), preferably around 0.5.

LossRate: The average packet loss rate. Typically the values for this parameter should be less than 0.05.

BurstLength: Average length of a packet loss burst. For a typical network, one should expect average burst length to be between 1 and 1.5. As the network congestion increases, the burst length increases.

Given these specifications, the parameters of the model are calculated as follows:

Low_jitter→min_delay=MinDelay

Low_jitter→max_delay=2*MeanDelay−(1−Volatility)*MaxDelay−Volatility*MinDelay

High_jitter→min_delay=low_jitter→max_delay

High_jitter→max_delay=MaxDelay

q=1/(CycleTime*(1−Volatility))

p=1/(CycleTime*Volatility)

b=1−1/BurstLength

r=1−b

f=LossRate/(BurstLength*(1−LossRate))

As indicated, only the min_delay and max_delay parameters for the Low jitter and High Jitter states are set. Then, the state machine is in the packet-loss state, the packets are lost, and therefore, the delay parameters are meaningless. Preferably, a uniform distribution of delay is used from the minimum to the maximum value. However, if the parameters are trained from the network, preferably Guassian distributions are used.

The network simulator is typically operated in the following manner: First, the parameters in the network simulator initialization object are set to the desired value, and a function call to the S2N_NetSimInit function is made. This function initializes the Network Simulator parameters, and prepares for execution. Next, when a packet is to be sent out to the network, the function S2N_InPacket is called with a pointer to the input packet. This function does not copy the packet, it just records the value of the pointer. Later, when the packet is to be recovered from the network, the network simulator simply returns the value of this pointer. The function S2N_ClockTick should be called every time a unit time elapses on the digital machine where the network simulator is being executed. S2N_ClockTick increments the internal clock of the network simulator by one clock tick. Immediately after this function call, one should make repeated calls to the function S2N_OutPacket. This function returns a pointer to the packet coming from the network, as long as there are packets arriving from the network for that time instant. Once there are no more packets for that particular time instant, the function returns a NULL

typedef struct{

short maxDelay; /* Maximum Jitter Delay in # of calling periods */
short minDelay; /~ Minimum Jitter Delay in # of calling periods */
short meanDelay; /* Any value between minDelay and maxDelay, specifying

the target levels of delay. */

short cycleTime; /* The model switches back and forth between low delay

and high delay periods. This parameter specifies the expected
duration of the complete cycle */

short lossRate; /* q15 Format rate of packet loss */
short r_burst_length; /* q15 format reciprocal of the packet loss burst length*/
short volatility; /* Q15on a scale from 0-1, determines the amount of time

spent in the low jitter state */

NKIND netId; /* wether ATM network or IP network. For ATM networks,

packets are forced to be in-order */

short maxpacketBurst; /* The maximum number of packets the network simulator

may throw out at a time (5) */

}S2N_init_struct;

While embodiments of the present invention are shown and described, it is envisioned that those skilled in the art may devise various modifications of the present invention without departing from the spirit and scope of the appended claims.

What is claimed is:

1. A jitter generation apparatus configured to capture time varying aspects of jitter and packet loss in real packet networks for testing and/or debugging jitter control algorithms, said jitter generation apparatus comprising a probabilistic markov model which includes at least one hidden state and a plurality of state-dependent distributions wherein at each packet arrival, said probabilistic markov model is configured to emit a number corresponding to the delay for that packet that comes from a distribution which is unique to the state that the model is in.

2. A jitter generation apparatus as recited in claim 1, said probabilistic markov model further comprising a state transition matrix, said probabilistic markov model being configured to make a transition to some other state, as defined by the state transition probability matrix, upon emitting the number.

3. A jitter generation apparatus as recited in claim 2, wherein parameters of the probabilistic markov model are configurable to provide one state that gives low jitter and another with high jitter, thereby reflecting time varying properties of the network.

4. A jitter generation apparatus as recited in claim 1, wherein said probabilistic markov model includes at least one state which always results in infinite delay, thereby modeling packet loss.

5. A jitter generation apparatus as recited in claim 1, wherein parameters of the probabilistic markov model are configurable based on actual network data which has been collected.

6. A jitter generation apparatus as recited in claim 5, further comprising an expectation-maximization algorithm which is applicable to the actual network data.

7. A jitter generation apparatus configured to capture time varying aspects of jitter and packet loss in real packet networks for testing and/or debugging jitter control algorithms, said jitter generation apparatus comprising a probabilistic markov model which includes at least one hidden state and a state transition matrix, said probabilistic markov model being configured to make a transition to some other state, as defined by the state transition probability matrix, upon emitting a number.

8. A jitter generation apparatus as defined in claim 7, further comprising a plurality of state-dependent distributions wherein at each packet arrival, said probabilistic markov model is configured to emit a number corresponding to the delay for that packet that comes from a distribution which is unique to the state that the model is in.

9. A jitter generation apparatus as recited in claim 7, wherein parameters of the probabilistic markov model are configurable to provide one state that gives low jitter and another with high jitter, thereby reflecting time varying properties of the network.

10. A jitter generation apparatus as recited in claim 7, wherein said probabilistic markov model includes at least one state which always results in infinite delay, thereby modeling packet loss.

11. A jitter generation apparatus as recited in claim 7, wherein parameters of the probabilistic markov model are configurable based on actual network data which has been collected.

12. A jitter generation apparatus as recited in claim 11, further comprising an expectation-maximization algorithm which is applicable to the actual network data.

13. A method of using a jitter generation apparatus to capture time varying aspects of jitter and packet loss in real packet networks for testing and/or debugging a jitter control algorithm, said method comprising providing a plurality of state-dependent distributions; receiving a packet; and retrieving a number from one of the distributions, said distribution being unique to the state that the model is in.

14. A method of using a jitter generation apparatus as recited in claim 13, wherein said jitter generation apparatus includes a state transition probability matrix and said method further comprises using the state transition probability matrix to determine whether to transition to another state.

15. A method of using a jitter generation apparatus as recited in claim 13, wherein said jitter generation apparatus includes a state which provides infinite delay, said method further comprising making a transition to said state, thereby modeling packet loss.
